(19) United States
(12) Patent Application Publication
(10) Pub. No.: US 2026/0242007 A1
(43) Pub. Date: Aug. 20, 2026

(54) STRUCTURAL ELEMENT OF A FRAME OF AN OFF-ROAD VEHICLE AND METHOD FOR MANUFACTURING SAME

(71) Applicant: BOMBARDIER RECREATIONAL PRODUCTS INC., Valcourt (CA)

(72) Inventors: Eric THEOBALD, Shefford (CA); Michel BOISCLAIR, St-Denis-de-Brompton (CA)

(21) Appl. No.: 19/390,538

(22) Filed: Nov. 15, 2025

Related U.S. Application Data
(60) Provisional application No. 63/723,628, filed on Nov. 22, 2024.

(51) Int. Cl. B62D 25/20

(52) U.S. Cl. CPC B62D 25/2072

(57) ABSTRACT

A weldless skid plate and a weldless frame support, both for an off-road vehicle, are disclosed. A method for manufacturing a structural element of a frame of an off-road vehicle is also disclosed. The method includes forming a profiled blank by cutting a periphery of a piece of sheet metal; cutting apertures in the piece of sheet metal withing the periphery; and stamping the profiled blank multiple times to form a plurality of portions of the manufactured structural element.

### CROSS-REFERENCE

This application claims priority to U.S. provisional patent application No. 63/723,628, filed on Nov. 22, 2024, the entirety of which is incorporated herein by reference.

### TECHNICAL FIELD

The present technology relates to structural elements of frames of off-road vehicles, and methods of manufacturing same.

### BACKGROUND

A frame of an off-road vehicle, such as an off-road side-by-side vehicle (SSV), needs to be strong and rugged in order to handle the rough off-road conditions for which such a vehicle is intended.

Such a frame is often mainly composed of bent tubular frame members that are welded to each other. Although fairly straightforward from a design perspective, this type of frame construction is relatively costly and time-consuming from a manufacturing perspective, and results in a heavy frame. For example, to make a single bend in a tubular frame member, part of the tubular frame member needs to be cut out, such as by removing wedge, where the member is to be bent, the tubular frame member is then bent, the edges where the cut was made, which are now adjacent, are then welded, and finally the weld needs finishing by grinding, polishing, and possibly post-weld heat treatment.

Therefore, there is a desire for an alternative way of manufacturing at least a portion of a frame of an off-road vehicle that can overcome at least some of the above-described drawbacks.

### SUMMARY

It is an object of the present technology to ameliorate at least some of the inconveniences present in the prior art.

According to one aspect of the present technology, there is provided a skid plate for an off-road vehicle. The skid plate has: a left portion configured for connecting to a left suspension mount of the off-road vehicle; a right portion configured for connecting to a right suspension mount of the off-road vehicle; a rear portion configured for connecting to a hitch receiver of the off-road vehicle; a frame connection portion configured for connecting to a frame member of the off-road vehicle; and a main portion connecting the left portion, the right portion, the rear portion and the frame connection portion to each other. The main portion is weldless.

In some embodiments, at least one of the left portion, the right portion and the rear portion has a reinforcement member.

In some embodiments, the reinforcement member of the at least one of the left portion, the right portion and the rear portion is a channel having an opened side.

In some embodiments, the channel of the at least one of the left portion, the right portion and the rear portion is an inverted U-shaped channel.

In some embodiments, the reinforcement member is a left reinforcement member, a right reinforcement member, and a rear reinforcement member. The left portion includes the left reinforcement member. The right portion includes the right reinforcement member. The rear portion includes the rear reinforcement member.

In some embodiments, the left reinforcement member defines at least one aperture for receiving the left suspension mount therein; and the right reinforcement member defines at least one aperture for receiving the right suspension mount therein.

In some embodiments, the left reinforcement member defines two apertures for receiving two lower arms of the left suspension mount therein; and the right reinforcement member defines two apertures for receiving two lower arms of the right suspension mount therein.

In some embodiments, the rear reinforcement member defines a recess for receiving a portion of the hitch receiver therein.

In some embodiments, the skid plate has a surface area; and the skid plate defines a plurality of apertures.

In some embodiments, a surface area of the plurality of apertures corresponds to at least 5 percent of the surface area of the skid plate.

In some embodiments, the surface area of the plurality of apertures corresponds to at least 8 percent of the surface area of the skid plate.

In some embodiments, the surface area of the plurality of apertures corresponds to at least 10 percent of the surface area of the skid plate.

In some embodiments, the frame connection portion is disposed at a front of the skid plate.

In some embodiments, the left portion, the right portion, the rear portion, and the frame connection portion surround the main portion.

In some embodiments, the skid plate is formed from steel sheet metal.

In some embodiments, the sheet metal is at least 2 mm thick.

In some embodiments, the skid plate has a weight of less than 4.3 kg.

In some embodiments, the weight is less than 4 kg.

In some embodiments, the weight is less than 3.7 kg.

In some embodiments, the weight is less than 3.6 kg.

In some embodiments, the skid plate has: a length; a front width at a front of the skid plate; and a rear width at a rear of the skid plate. The front width is greater than the rear width.

In some embodiments, the front width is greater than the length.

In some embodiments, the rear width is smaller than the length.

In some embodiments, the main portion has a stamped recess.

In some embodiments, the left portion, the right portion, the rear portion, the frame connection portion, and the main portion together define a monolithic skid plate.

In some embodiments, the left portion, the right portion, the rear portion, the frame connection portion, and the main portion are made from a single piece of sheet metal.

In some embodiments, the left portion, the right portion, the rear portion, the frame connection portion, and the main portion are stamped from the single piece of sheet metal.

In some embodiments, the left portion, the right portion, the rear portion, the frame connection portion, and the main portion are connected to each other without welds, mechanical fasteners, and adhesives.

According to another aspect of the present technology, there is provided a frame support for an off-road vehicle. The support element has: a left portion configured for connecting to a left suspension mount of the off-road vehicle; a right portion configured for connecting to a right suspension mount of the off-road vehicle; at least one torsion bar mounting portion configured for connecting to at least one torsion bar mount of the off-road vehicle; a skid plate connection portion configured for connecting to a skid plate of the off-road vehicle; and at least one powertrain mounting portion configured for connecting to at least one powertrain mount of the off-road vehicle. Connections between the left portion, the right portion, the at least one torsion bar mounting portion, the skid plate connection portion, and the at least one powertrain mounting portion are weldless.

In some embodiments, connections between the left portion, the right portion, the at least one torsion bar mounting portion, the skid plate connection portion, and the at least one powertrain mounting portion are free of mechanical fasteners, and adhesives.

In some embodiments, the left portion, the right portion, the at least one torsion bar mounting portion, the skid plate connection portion, and the at least one powertrain mounting portion together define the frame support as a monolithic frame support.

In some embodiments, the left portion, the right portion, the at least one torsion bar mounting portion, the skid plate connection portion, and the at least one powertrain mounting portion are made from a single piece of sheet metal.

In some embodiments, the left portion, the right portion, the at least one torsion bar mounting portion, the skid plate connection portion, and the at least one powertrain mounting portion are stamped from the single piece of sheet metal.

In some embodiments, the at least one torsion bar mounting portion configured for connecting to at least one torsion bar mount of the off-road vehicle is left and right torsion bar mounting portions configured for connecting to left and right torsion bar mounts of the off-road vehicle.

In some embodiments, the at least one powertrain mounting portion configured for connecting to at least one powertrain mount of the off-road vehicle is left and right powertrain mounting portions configured for connecting to a powertrain mount of the off-road vehicle extending between the left and right powertrain mounting portions.

In some embodiments, a support body defines the left portion, the right portion, the at least one torsion bar mounting portion, the skid plate connection portion, and the at least one powertrain mounting portion. The support body has a first body portion and a second body portion. The second body portion is generally perpendicular to the first body portion. The support body is configured such that, with the frame support connected to the off-road vehicle, the first body portion extends generally vertically, the second body portion extends generally horizontally, and the second body portion extends forward from an upper end of the first body portion.

In some embodiments, the first body portion defines the at least one torsion bar mounting portion.

In some embodiments, a lower portion of the first body portion defines the skid plate connection portion.

In some embodiments, the second body portion defines the at least one powertrain mounting portion.

In some embodiments, a left side of the first body portion and a left side of the second body portion define the left portion; and a right side of the first body portion and a right side of the second body portion define the right portion.

In some embodiments, the second body portion comprises a left arm and a right arm laterally spaced from the left arm.

In some embodiments, the at least one powertrain mounting portion configured for connecting to at least one powertrain mount of the off-road vehicle has: a left powertrain mounting portion defined by the left arm and configured for connecting to a left side of a powertrain mount of the off-road vehicle extending between the left arm and the right arm; and a right powertrain mounting portion defined by the right arm and configured for connecting to a right side of the powertrain mount.

In some embodiments, a left side of the first body portion and the left arm define the left portion; and a right side of the first body portion and the right arm define the right portion.

In some embodiments, the left arm has a left reinforcement lip; and the right arm has a right reinforcement lip.

In some embodiments, each of the left and right reinforcement lip is at least 8 mm high.

In some embodiments, each of the left and right reinforcement lip is at least 16 mm high.

In some embodiments, each of the left and right reinforcement lip is at least 24 mm high.

In some embodiments, the first body portion defines an upper U-shaped edge extending between the left and right arms.

In some embodiments, the upper U-shaped edge has a reinforcement lip being at least 8 mm long.

In some embodiments, the reinforcement lip of the U-shaped edge is at least 16 mm long.

In some embodiments, the reinforcement lip of the U-shaped edge is at least 24 mm long.

In some embodiments, the first body portion defines a hitch connection portion for connecting to a hitch receiver of the off-road vehicle.

In some embodiments, the first body portion has a stamped recess.

In some embodiments, the recess has a depth of at least 20 mm.

In some embodiments, the recess has a depth of at least 25 mm.

In some embodiments, the recess has a depth of at least 30 mm.

In some embodiments, the frame support defines a plurality of apertures.

In some embodiments, the frame support is formed from steel sheet metal.

In some embodiments, the sheet metal is at least 2 mm thick.

In some embodiments, the frame support has: a length; a width; and a height. The width is greater than at least one of the length and the height.

In some embodiments, the width is greater than the length and greater than the height.

According to another aspect of the present technology, there is provided a method for manufacturing a structural element of a frame of an off-road vehicle. The method includes forming a profiled blank by cutting a periphery of the profiled blank in a piece of sheet metal. The method also includes cutting apertures in the piece of sheet metal within the periphery of the profiled blank. The method also includes stamping the profiled blank multiple times to form a plurality of portions of the manufactured structural element.

In some embodiments, the manufactured structural element is weldless.

In some embodiments, cutting the periphery of the profiled blank includes laser-cutting the periphery of the profiled blank.

In some embodiments, cutting the apertures in the piece of sheet metal comprises laser-cutting the apertures in the piece of sheet metal.

In some embodiments, cutting the periphery of the profiled blank comprises punching the periphery of the profiled blank.

In some embodiments, cutting the apertures in the piece of sheet metal comprises punching the apertures in the piece of sheet metal.

In some embodiments, the structural element is a skid plate as recited above in the summary; and the plurality of portions of the manufactured structural element comprises the left portion, the right portion, the rear portion, the frame connection portion, and the main portion.

In some embodiments, the structural element is a skid plate as recited above in the summary; and the plurality of portions of the manufactured structural element comprises the left portion, the right portion, the at least one torsion bar mounting portion, the skid plate connection portion and the at least one powertrain mounting portion.

According to another aspect of the present technology, there is provided a method for assembling an off-road vehicle. The method includes manufacturing a structural element of a frame of the off road-vehicle according to the method recited above in the summary; and welding the structural element to at least one other component of the off-road vehicle. The at least one other component is at least one of a suspension mount, a hitch receiver, and a frame member.

In some embodiments, the method also includes fastening at least one of a torsion bar mount and a powertrain mount to the structural element.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

For purposes of the present application, the term “monolithic” means “consisting of a single piece.”

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an off-road vehicle;

FIG. 2 is a perspective view, taken from a rear, right side of a frame of the vehicle of FIG. 1;

FIG. 3 is a rear elevation view of the frame of FIG. 2;

FIG. 4 is a left side elevation view of the frame of FIG. 2;

FIG. 5 is a perspective view, taken from a rear, right side of elements of a rear portion of the vehicle of FIG. 1;

FIG. 6 is a perspective view, taken from a rear, right side of part of a rear frame portion of the frame of FIG. 2, with a ball hitch connected thereto;

FIG. 7 is a perspective view, taken from a front, right side of the rear frame portion of the frame of FIG. 2;

FIG. 8 is a top plan view of part of the rear frame portion of FIG. 7;

FIG. 9 is a cross-sectional view of part of the rear frame portion of FIG. 7, taken through line 9-9 of FIG. 8;

FIG. 10 is a bottom plan view of part of the rear frame portion of FIG. 7;

FIG. 11 is a perspective view taken from a front, right side of a skid plate of the frame of FIG. 2;

FIG. 12 is a rear elevation view of the skid plate of FIG. 11;

FIG. 13 is a front elevation view of the skid plate of FIG. 11;

FIG. 14 is a left side elevation view of the skid plate of FIG. 11;

FIG. 15 is a top plan view of the skid plate of FIG. 11;

FIG. 16 is a bottom plan view of the skid plate of FIG. 11;

FIG. 17 is a perspective view taken from a front, right side of a frame support of the frame of FIG. 2;

FIG. 18 is a front elevation view of the frame support of FIG. 17;

FIG. 19 is a rear elevation view of the frame support of FIG. 17;

FIG. 20 is a left side elevation view of the frame support of FIG. 17;

FIG. 21 is a top plan view of the frame support of FIG. 17;

FIG. 22 is a bottom plan view of the frame support of FIG. 17;

FIG. 23 is a flowchart of a method for assembling the vehicle of FIG. 1; and

FIGS. 24 to 31 illustrate consecutive step of a method for manufacturing the skid plate of FIG. 11 taken from a top plan view.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology will be described below with respect to an off-road side-by-side vehicle (SSV) designed to accommodate three riders (one driver and two passengers) seated side-by-side in an open cockpit area. However, it is contemplated that some aspects of the technology could be adapted for use on other kinds of off-road vehicles having an open cockpit area, such as a single passenger off-road vehicle, two-, four-or more passenger SSVs, a straddle-seat all-terrain vehicle (ATV), and the like.

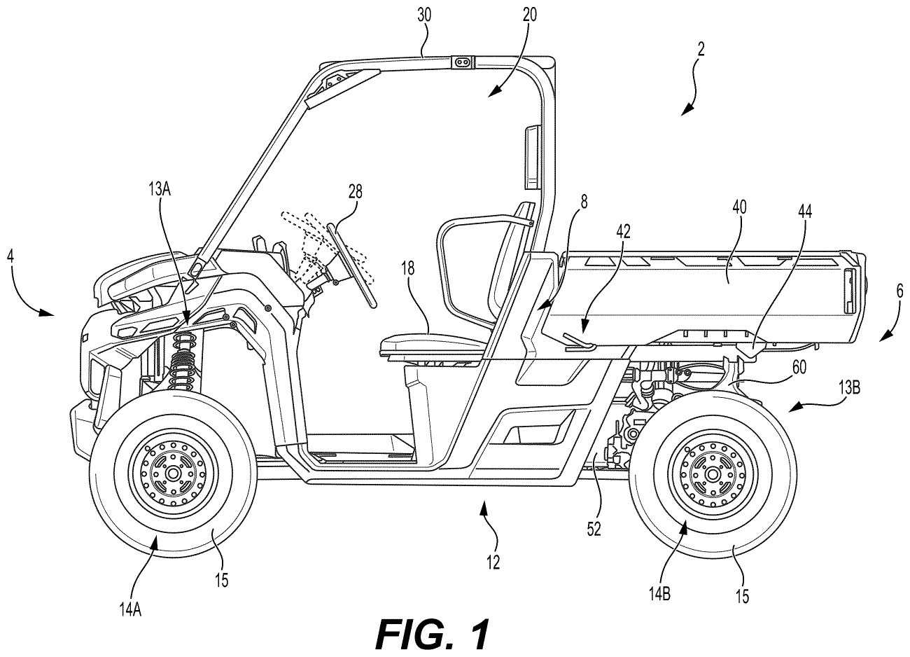

FIG. 1 illustrates an off-road SSV 2 (hereinafter the “vehicle 2”) having a front end 4, a rear end 6, and left and right sides 8, defined consistently with the forward travel direction of the vehicle 2. The vehicle 2 includes a frame 12 to which all other parts of the vehicle 2 are connected, directly or indirectly. The frame 12 has a front frame portion 12A, a middle frame portion 12B and a rear frame portion 12C.

The vehicle 2 includes a pair of front wheels 14A and a pair of rear wheels 14B. Each of the wheels 14A, 14B has a tire 15. Each front wheel 14A is suspended from the front frame portion 12A a front suspension 13A. Each rear wheel 14B is suspended from the rear frame portion 12C via a rear suspension 13B. Each of the wheels 14A, 14B is provided with a brake assembly (not shown) in the form of a disc-type brake mounted onto a hub of its respective wheel 14A or 14B. Other types of brakes are contemplated.

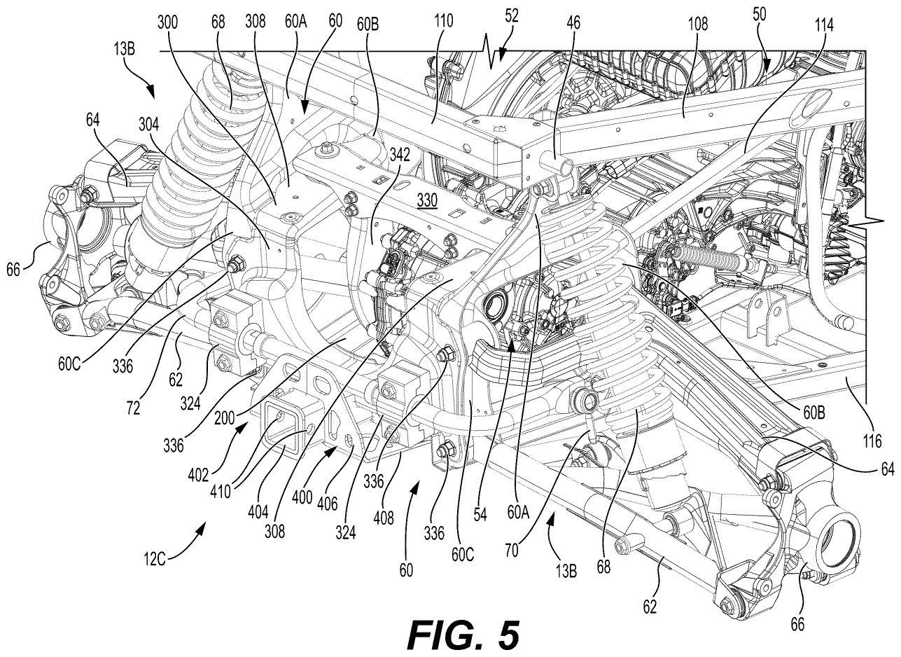

The front and rear wheels 14A, 14B are connected to a motor 50 (FIG. 5) via a drivetrain. The motor 50 and the drivetrain together form a powertrain of the vehicle 2. In the illustrated embodiment, the motor 50 is an internal combustion engine (hereinafter the “engine 50”), but it is contemplated that the motor could be of another type, such as an electric motor or a hybrid. With reference to FIG. 5, in the present embodiment, the drivetrain includes a continuously variable transmission (CVT) 52 and a transaxle 54. The engine 50 drives the CVT 52. The CVT 52 drives the transaxle 54. The transaxle 54 drives the rear wheels 14B via rear half-shafts (not shown). The transaxle 54 also drives a front differential (not shown), which drives the front wheels 14A via front half-shafts (not shown).

With reference to FIG. 1, the vehicle 2 has an open-air cockpit area 20 disposed generally in the middle portion of the vehicle 2. The cockpit area 20 comprises a left, middle, and right seats 18 (only the left one being shown) disposed side-by-side to accommodate a driver and two passengers (collectively referred to herein as riders). It is contemplated that the vehicle 2 could have only one or two seats. In the present embodiment, the seats 18 are bucket seats, but other types of seats are contemplated. A roll cage 30, connected to the frame 12, is disposed over the cockpit area 20. It is contemplated that the cockpit area 20 could be closed or partially closed by one or more of a windshield, side windows, a rear window, and side doors.

A steering assembly, including a steering wheel 28, is disposed in front of the driver seat 18, which in this embodiment, is the left seat 18. The steering assembly 26 is operatively connected to the two front wheels 14A to permit steering of the vehicle 2. It is contemplated that the steering wheel 28 could be disposed in front of the right seat 18.

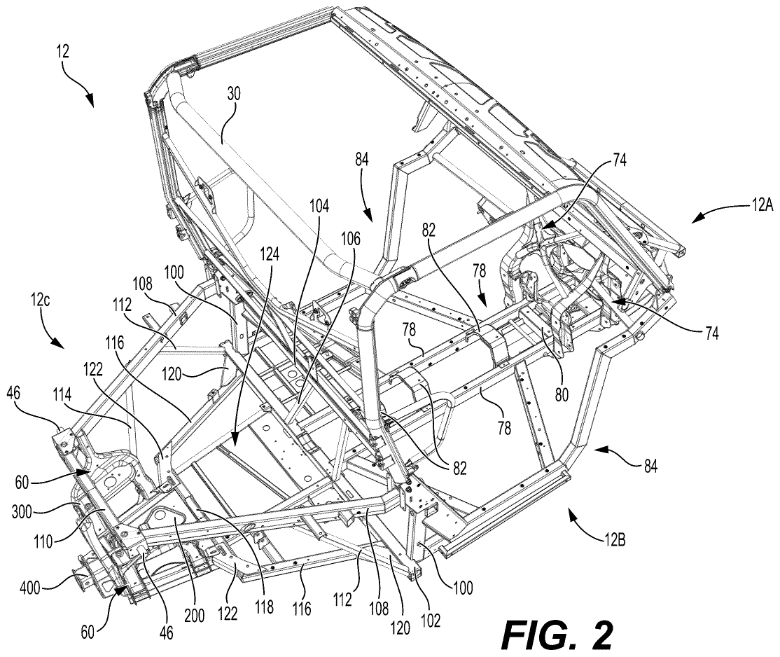

The vehicle 2 also includes a cargo box 40 disposed rearwardly of the cockpit area 20. The cargo box 40, which is mounted to the rear frame portion 12C, is generally rectangular and opened at the top. It is contemplated that the cargo box 40 could have a top cover, and could have a different shape than that shown herein. The front end of the cargo box 40 is secured to the rear frame portion 12C by latches 42 (only part of the left latch 42 being shown). The rear end of the cargo box 40 extends rearward of the rear frame portion 12C and the rear wheels 14B. The cargo box 40 is pivotally connected to the rear frame portion 12 by a pair of brackets 44 (only the left bracket 44 being shown). The brackets 44 are pivotally connected to laterally extending rods 46 (FIG. 2) connected to the rear frame portion 12C. By unlatching the latches 42, the front end of the cargo box 40 can be pivoted upwards to access the engine 50 and other internal components of the vehicle 2 located thereunder, or to unload the contents of the cargo box 40. A pneumatic piston (not shown) extending upwards from the rear frame portion 12C is connected to the lower surface of the cargo box 40 in order to pivot the cargo box 40 and to support the cargo box 40 in its raised position. It is contemplated that the cargo box 40 could be omitted.

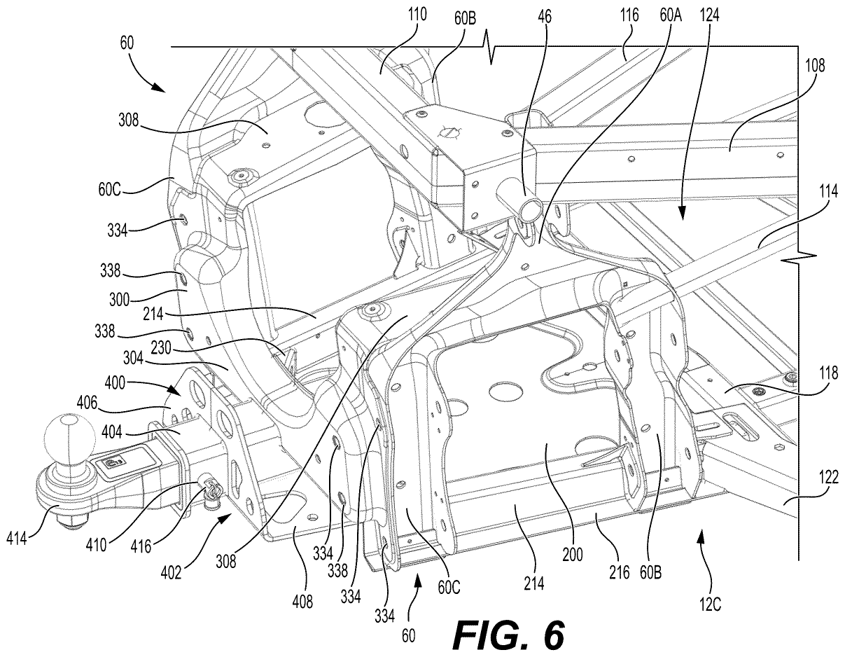

With reference to FIG. 5, the rear suspensions 13B and their connection to the frame 12 will now be described. The right rear suspension 13B extends rightward from a right suspension mount 60 and the left rear suspension 13B extends leftward from a left suspension mount 60. The left and right rear suspension mounts 60 are mirror images of one another and as such, only the right one will be described herein. With reference to FIG. 6, the right rear suspension mount 60 has an inverted Y-shape, with an upper arm 60A connected to two lower arms 60B, 60C which are longitudinally spaced from each other. The left rear suspension 13B is a mirror image of the right rear suspension 13B, and as such, only the right rear suspension 13B will be described below. Corresponding and similar elements of the left and right rear suspensions 13B are labeled with the same reference numerals in the figures. It is contemplated that some of the elements of the right rear suspension 13B may be different from the corresponding elements of the left rear suspension 13B. For example, suspension elements on one side may differ from suspension elements on the other side to accommodate elements of the vehicle 2 that are present on only one side or that differ between each side.

The right rear suspension 13B includes a lower arm 62 and an upper arm 64, each extending laterally outward from the inverted Y-shaped right suspension mount 60. The lower A-arm 62 includes a front member pivotally connected to the lower front arm 60B of the right suspension mount 60, and a rear member pivotally connected to the lower rear arm 60C of the right suspension mount 60. The right end of the lower arm 62 is connected to a lower portion of a knuckle 66. The rear right wheel 14B is rotationally connected to the knuckle 66. The upper arm 64 is disposed above the lower arm 62 and also includes a front member and rear member. The front member of the upper arm 64 is pivotally connected to the lower front arm 60B, and the rear member is pivotally connected to the lower rear arm 60C. The right end of the upper arm 64 is connected to the upper portion of the knuckle 66. A shock absorber 68 extends upward and leftward from the lower arm 62 to the upper arm 60A of the right suspension mount 60 of the frame 12.

A link 70 extends upwards from the lower arm 62 of the right rear suspension 13B. The upper end of this link 70 is connected to the right end of a torsion bar 72. The left end of the torsion bar 72 is connected to the link 70 (not shown) of the left rear suspension 13B. The torsion bar 72 is pivotally connected the rear frame portion 12C. The connection of the torsion bar 72 to the rear frame portion 12C will be described in more detail below.

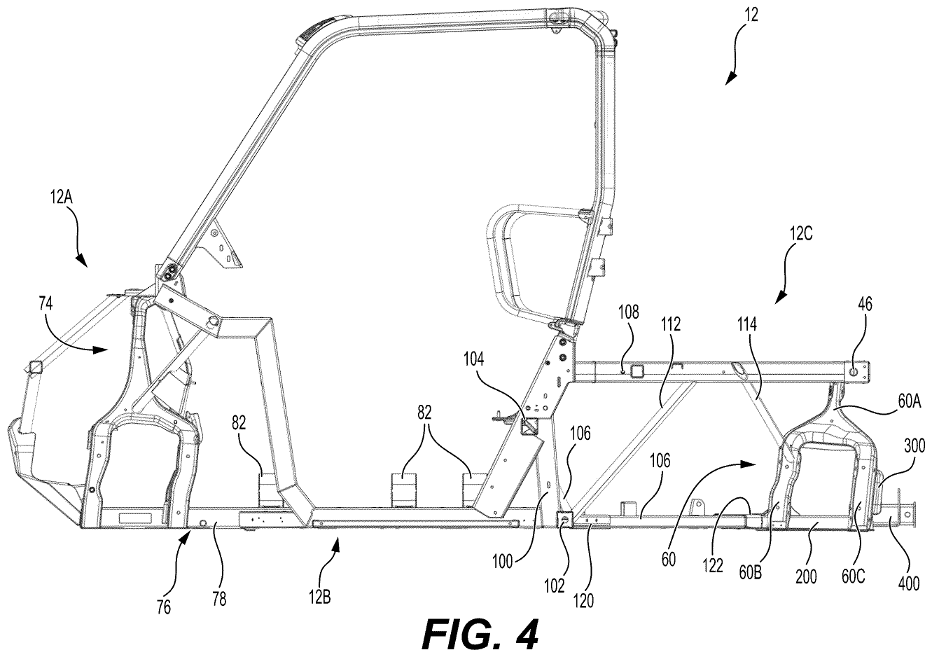

With reference to FIGS. 2 and 4, the front portion 12A of the frame 12 includes inverted Y-shaped suspension mounts 74 similar to the suspension mounts 60 described above. Each front suspension 13A is connected between its corresponding suspension mount 74 and front wheel 14A.

With reference to FIGS. 2 and 4, a central support structure 76, including a pair of parallel beams 78, extends longitudinally along the bottom of the front and middle frame portions 12A, 12B laterally inward of the suspension mounts 74. The left beam 78 is connected to the lower end of the left suspension mount 74. The right beam 78 is connected to the lower end of the right suspension mount 74. A reinforcing cross member 80 and inverted U-shaped pieces of sheet metal 82 are connected between the beams 78.

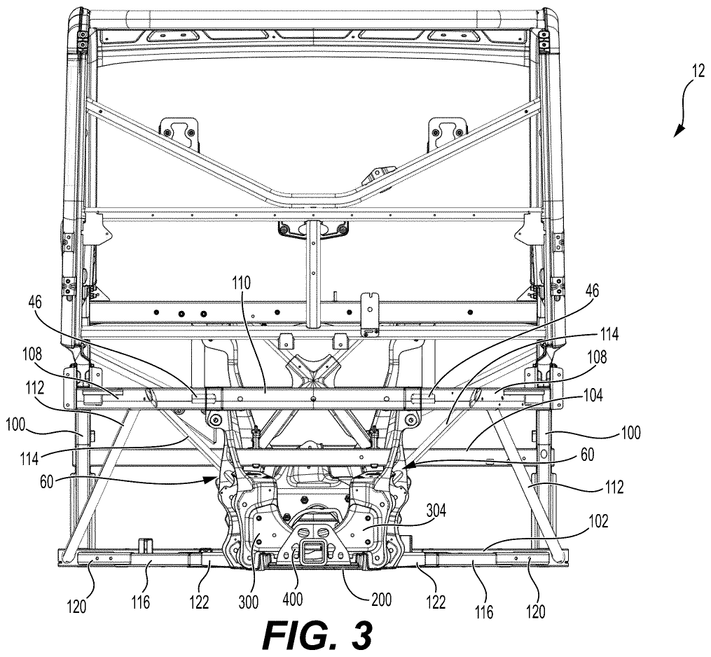

With reference to FIGS. 2 to 4, the middle frame portion 12B includes a left side support structure 84 disposed on the left of the left beam 78 and a right side support structure 84 disposed on the right of the right beam 78. The support structures 84 are made of hollow rectangular beams.

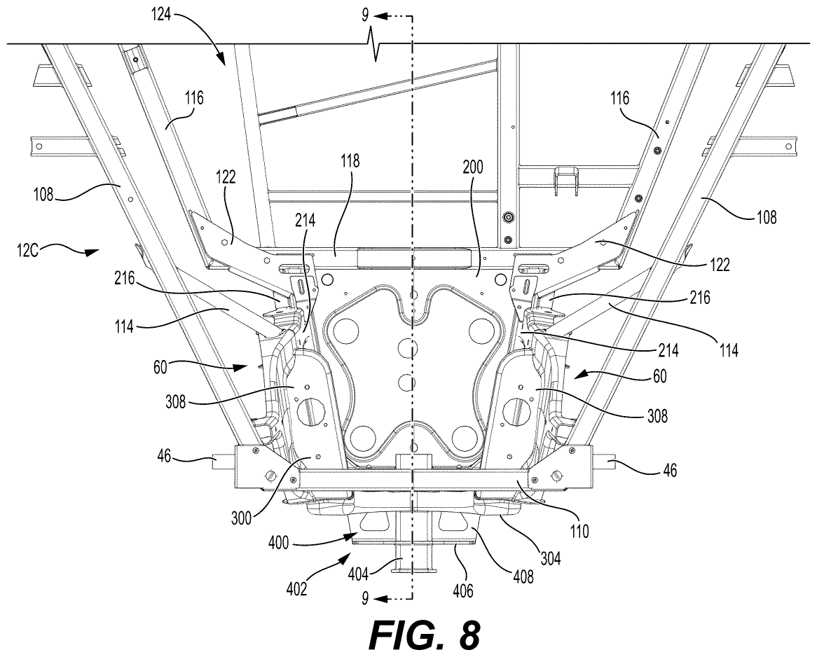

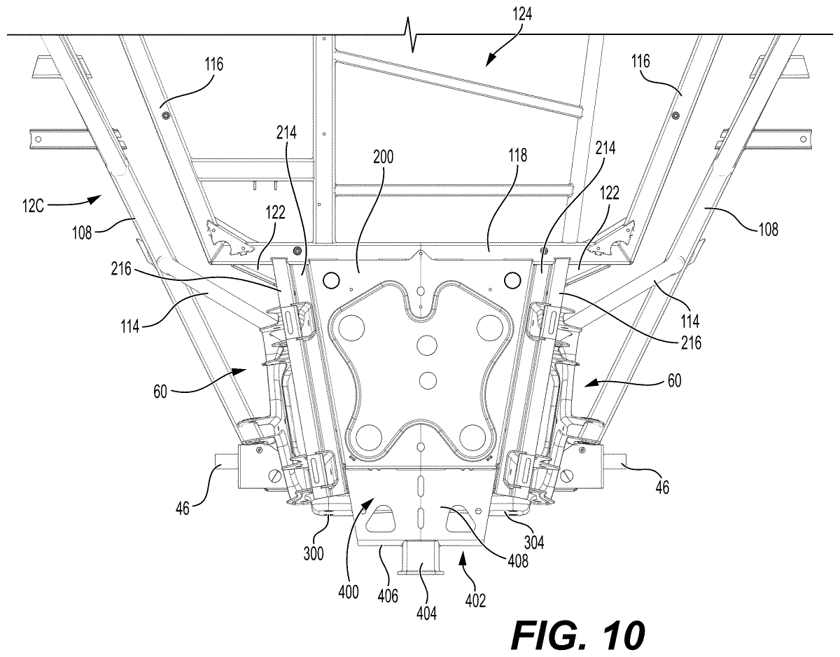

With reference to FIGS. 6 to 10, the rear frame portion 12C will be described in more detail. The rear frame portion 12C has left and right front members 100. A lateral member 102 is connected to the back of lower ends of the front members 100. A lateral member 104 is connected to the front of middle portions of the front members 100. Cross-members 106 extend between the lateral members 102, 104.

A left upper member 108 extends rearward and laterally inward from the upper end of the left front member 100. A right upper member 108 extends rearward and laterally inward from the upper end of the right front member 100. A lateral member 110 extends laterally between the rear ends of the members 108. The rods 46 extend from the ends of the lateral member 110. A left cross-member 112 extends between the left end of the lateral member 102 and the left upper member 108. Another left cross-member 114 is disposed rearward of the left cross-member 112 and extends between the left upper member 108 and the lower arm 60B of the left rear suspension mount 60. A right cross-member 112 extends between the right end of the lateral member 102 and the right upper member 108. Another right cross-member 114 is disposed rearward of the right cross-member 112 and extends between the right upper member 108 and the lower arm 60B of the right rear suspension mount 60.

A left lower member 116 extends rearward and laterally inward from a left end portion of the lateral member 102. A right lower member 116 extends rearward and laterally inward from a right end portion of the lateral member 102. A lateral member 118 extends laterally between the rear ends of the members 116. A left lower cross-member 120 extends rearward and laterally inward from the left end portion of the lateral member 102 to the left lower member 116. A right lower cross-member 120 extends rearward and laterally inward from the right end portion of the lateral member 102 to the right lower member 116. Brackets 122 connect the rear ends of the lower members 116 to the ends of the lateral member 118.

A lattice of frame members 124 is disposed within and connected to the perimeter defined by the lateral members 102, 118 and the lower members 116. The lattice of frame members 124 supports the engine 50.

The members 100, 102, 104, 106, 108, 110, 112, 114, 116, 118, 120, 124 of the rear frame portion 12C are made of hollow metal beams that are welded to each other.

The rear frame portion 12C also includes a skid plate 200, a frame support 300, and a hitch receiver 400. The skid plate 200 extends reward of the lateral member 118. The skid plate 200 is connected to the lateral member 118 and to the lower ends of the lower arms 60B, 60B of the suspension mounts 60. The frame support 300 is connected to the rear end of the skid plate 200 and to the suspension mounts 60. The hitch receiver 400 is connected to and extends rearward from the skid plate 200 and the frame support 300. The skid plate 200, the frame support 300, the hitch receiver 400 and their connections to the other elements of the rear frame portion 12C will be described in more detail below.

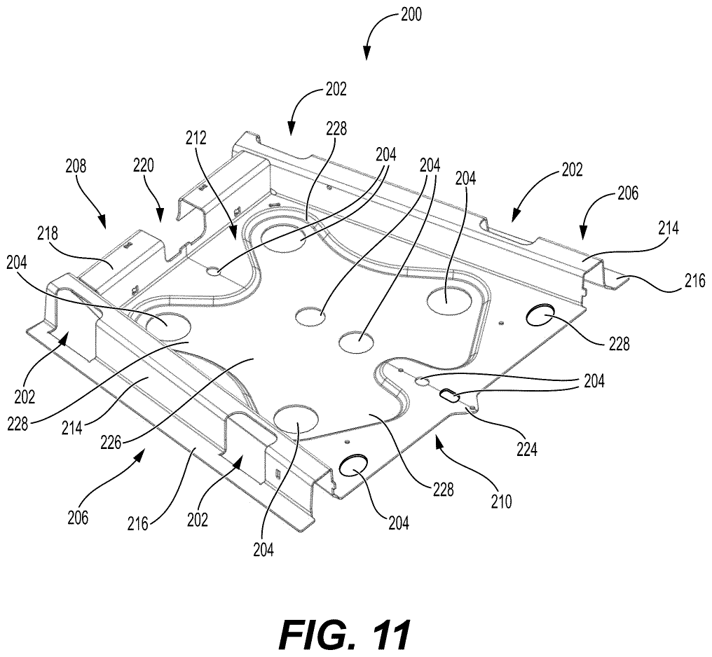

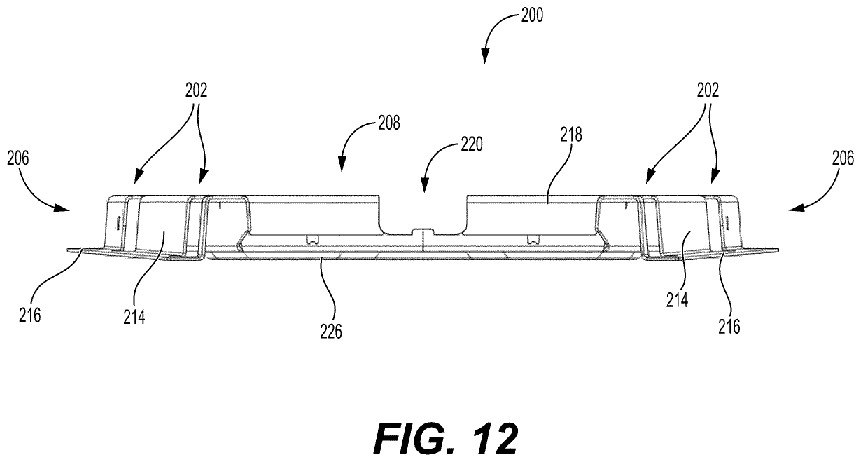

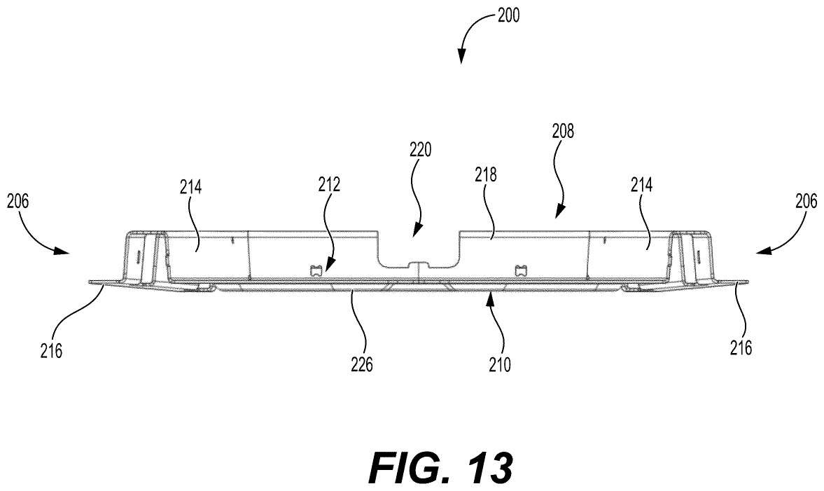

Turning now to FIGS. 11 to 16, the skid plate 200 will be described in more detail. The skid plate 200 is manufactured by stamping as a monolithic skid plate 200. In other words, the skid plate 200 consists of a single piece. In the present embodiment, the skid plate 200 is formed from of a single piece of steel sheet metal. It is contemplated that metals other than steel, such as aluminum for example, could be used. It is also contemplated that materials other than metals, such as thermoplastic composites, could be used. In some embodiments, the sheet metal is at least 2 mm thick. The skid plate 200 is manufactured without welds, and as such is considered to be weldless. The skid plate 200 is also manufactured without mechanical fasteners and without adhesive. As will be described below, the skid plate 200 is welded to the other components of the rear frame 12C, but the skid plate 200 itself is formed without welds prior to its integration with the rest of the rear frame portion 12C. The structure of the skid plate 200 shown in FIGS. 11 to 16 is the result of the stamping manufacturing process which will be described below.

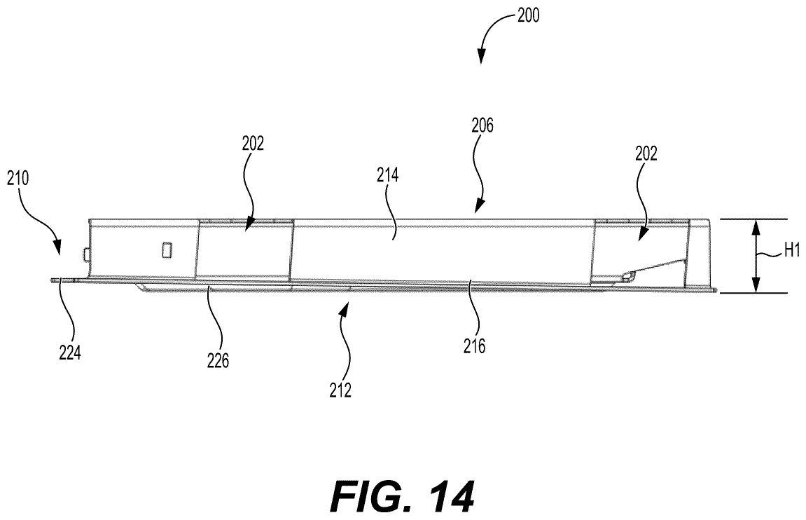

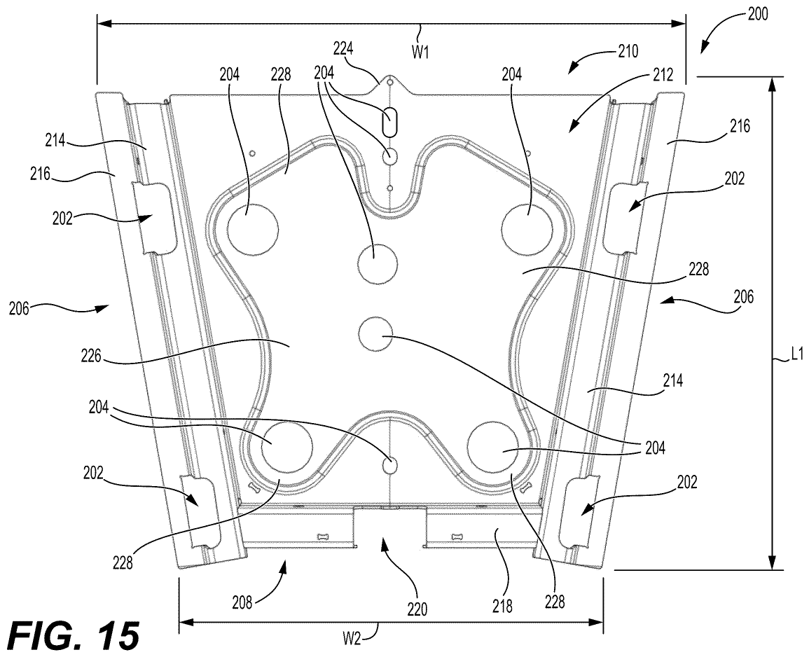

With reference to FIG. 15, as viewed from above, the skid plate 200 has a generally trapezoidal shape. Other shapes are contemplated. The skid plate 200 has a length L1, a front width W1, and a rear width W2. As can be seen, in the present embodiment, the front width W1 is greater than the rear width W2, the front width W1 is greater than the length L1, and the rear width W2 is smaller than the length L1. In one embodiment, the length L1 is about 430 mm, the front width W1 is about 515 mm, and the rear width W2 is about 370 mm. With reference to FIG. 14, the skid plate 200 has a height H1. In one embodiment, the height H1 is about 40 mm.

The skid plate 200 defines a plurality of apertures, such as apertures 202, 204. The apertures 202 serve a function which will be described further below while also providing weight saving. The apertures 204 provide weight saving and could be omitted in some embodiments. As can be seen in the Figures, the skid plate 200 has a number of apertures other than the apertures 202, 204, however these are too small and numerous to label in the Figures without affecting the overall clarity of the Figures, and as such have not been labeled. In some embodiments, a surface area of the apertures, including the apertures 202, 204, correspond to at least 5 percent of a surface area of the skid plate 200. In some embodiments, the surface area of the apertures corresponds to at least 8 percent of the surface area of the skid plate 200. In some embodiments, the surface area of the apertures corresponds to at least 10 percent of a surface area of the skid plate 200. The use of sheet metal, the stamping process, the lack of welds, and the apertures 202, 204 contribute to the skid plate 200 being relatively low compared to at least some skid plates having similar dimensions. In some embodiments, the skid plate 200 has a weight of less than 4.3 kg. In some embodiments, the skid plate 200 has a weight of less than 4.0 kg. In some embodiments, the skid plate 200 has a weight of less than 3.7 kg. In some embodiments, the skid plate 200 has a weight of less than 3.6 kg.

The skid plate 200 has left and right portions 206, a rear portion 208, a frame connection portion 210, and a main portion 212. The left and right portions 206 are configured for connecting to the left and right suspension mounts 60 respectively. The rear portion 208 is configured for connecting to the hitch receiver 400. The frame connection portion 210 is configured for connecting to the rear frame portion 12C. The main portion 212 is surrounded by the left and right portions 206, the rear portion 208, and the frame connection portion 210. The main portion 212 connects the left and right portions 206, the rear portion 208, and the frame connection portion 210 to each other without welds, mechanical fasteners, and adhesives. As such, the main portion 212 is weldless. In the present embodiment, the left and right portions 206, the rear portion 208, the frame connection portion 210, and the main portion 212 are stamped from a single piece of sheet metal and together define the monolithic skid plate 200.

The left and right portions 206 have left and right reinforcement members 214 respectively. A lower end of a laterally inward side of each reinforcement member 214 is connected to the main portion 212. Each portion 206 also has a flange 216 connected to a lower end of a laterally outward side of its corresponding reinforcement member 214. In the present embodiment, each reinforcement member 214 is an inverter U-shaped channel, with its lower side being the opened side. As can be seen in the figures, for each reinforcement member 214, the lateral sides of the reinforcement member 214 taper such that the reinforcement member 214 is narrower at the top than at the bottom. Two of the apertures 202 are defined in each of the reinforcement members 214. The apertures 202 of the left reinforcement member 214 are configured to receive the lower arms 60B, 60C of the left suspension mount 60 therein. The apertures 202 of the right reinforcement member 214 are configured to receive the lower arms 60B, 60C of the right suspension mount 60 therein. It is contemplated that each reinforcement member 214 could have only one or more than two apertures 202 depending on the configuration of the suspension mount 60. It is also contemplated that in some embodiments, the reinforcement members 214 could not have apertures 202, such that the suspension mount 60 attaches to outer surfaces of the reinforcement member 214 without penetrating the reinforcement members 214.

The rear portion 208 has a rear reinforcement member 218. A lower end of a front side of the reinforcement member 218 is connected to the main portion 212. In the present embodiment, the reinforcement member 218 is an inverter U-shaped channel, with its lower side being the opened side. The front and rear sides of the reinforcement member 218 taper such that the reinforcement member 218 is narrower at the top than at the bottom. The reinforcement member 218 is disposed laterally between the rear ends of the left and right reinforcement members 214, such that the left and right ends of the rear reinforcement member 218 are disposed next to the left and right reinforcement member 214 respectively. The rear reinforcement member 218 defines a recess 220 for receiving a portion of the hitch receiver 400 therein as will be described in more detail below. It is contemplated that in some embodiments, the rear reinforcement member 218 could not have the recess 220.

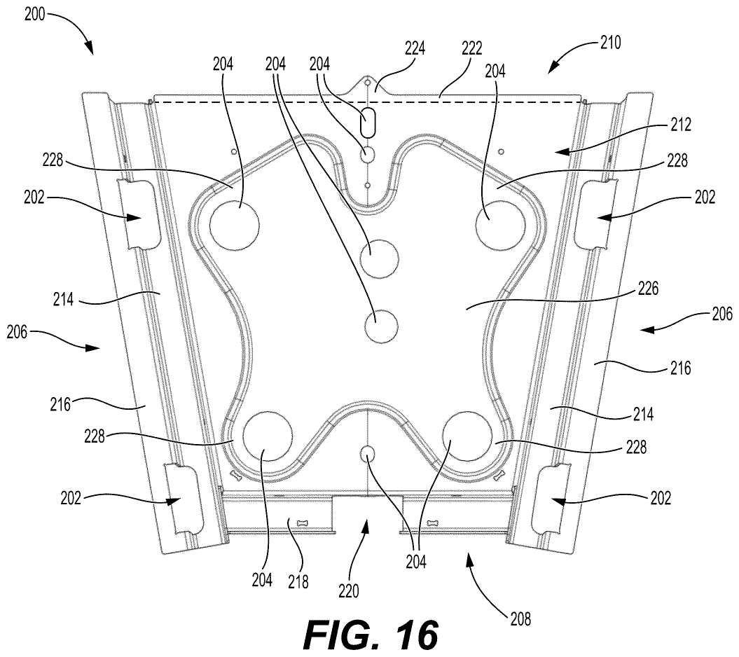

The frame connection portion 210 is disposed at the front of the skid plate 200 directly forward of the main portion 212. The frame portion 210 is disposed forward of the front ends of the reinforcement members 214 (indicated by dashed line 222 in FIG. 16). The frame connection 210 has a central generally triangular protrusion 224 comprising a pre-defined aperture.

The main portion 212 has a stamped recess 226 (i.e. a recess formed by stamping). The stamped recess 226 defines the lowest portion of the skid plate 200 as can be seen in FIG. 14. The stamped recess 226 reinforces the main portion 212. In the present embodiment, the stamped recess 226 is about 6 mm deep, but other depths are contemplated. In the present embodiment, the stamped recess 226 has four lobes 228. Each of the lobes 228 has one of the apertures 204 defined therein. Two more of the apertures 204 are defined in the stamped recess 226 near a center thereof. It is contemplated that the recess could have a shape that is different from the one illustrated in the Figures.

The skid plate 200 is connected to the other components of the vehicle 2 by welding. The placement of the skid plate 200 in the rear frame portion 12C is such that the lower arms 60B, 60C of the left and right suspension mounts 60 are received in the apertures 202 of the reinforcement members 214 of the skid plate 200, and such that the frame connection portion 210 of the skid plate 200 abuts a bottom of the lateral member 118. The placing may comprise fastening (e.g., riveting) the lateral member 118 to the skid plate 200 through the pre-defined aperture of the protrusion 224 of the skid plate 200 and through a pre-defined aperture of the lateral member 118. The lowers arms 60B, 60C are welded to the reinforcement members 214 along the edges of the apertures 202. The frame connection portion 210 is welded to the lateral member 118 along its width. The brackets 122 are also welded to the reinforcement members 214. Left and right braces 230 (only a left one of which is shown in FIG. 6, and 7) are welded between the left and right reinforcement members 214 and the rear reinforcement member 218. It is contemplated that the braces 230 could be omitted in some embodiments.

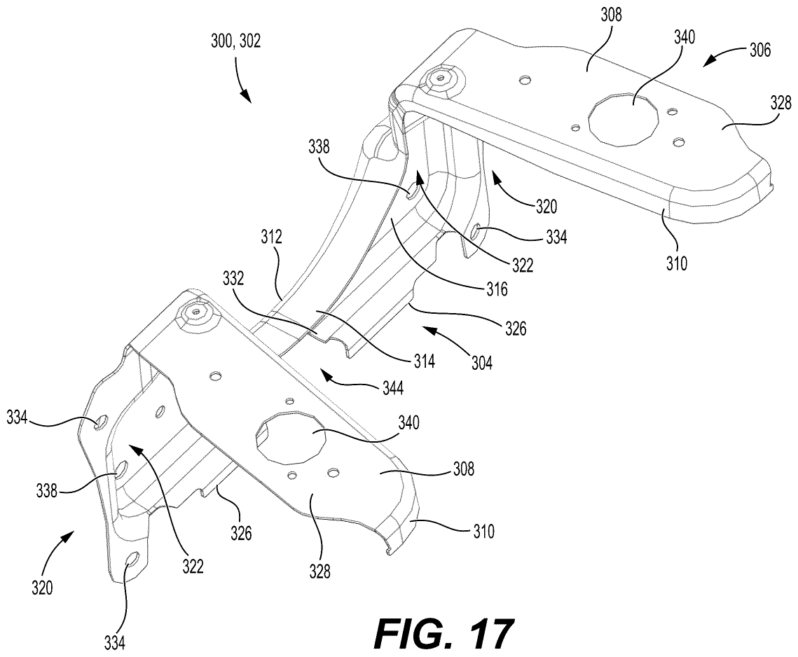

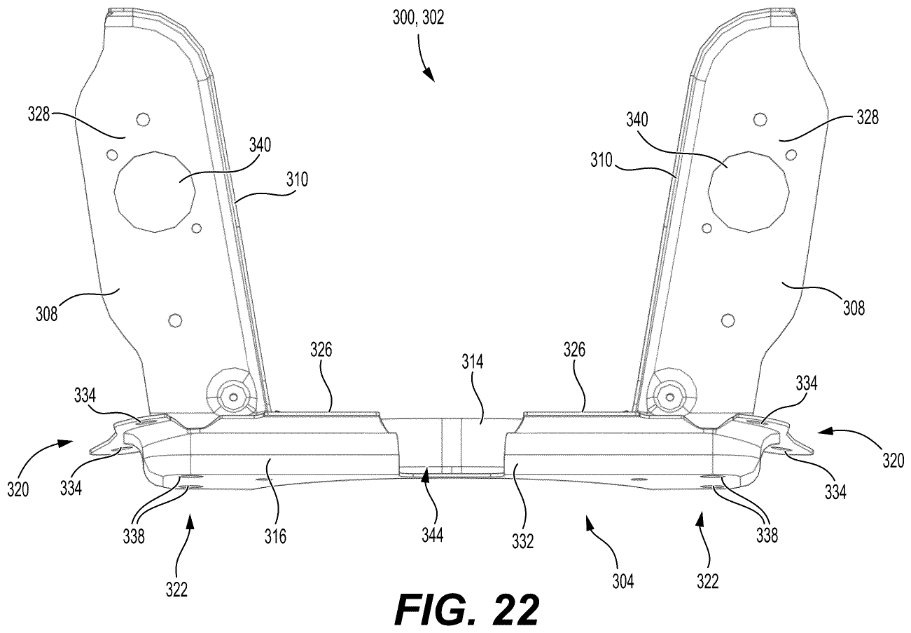

Turning now to FIGS. 17 to 22, the frame support 300 will be described in more detail. The frame support 300 is manufactured by stamping as a monolithic frame support 300. In other words, the frame support 300 consists of a single piece, which in the present application is referred to as the support body 302. In the present embodiment, the frame support 300 is formed from of a single piece of steel sheet metal. It is contemplated that metals other than steel, such as aluminum for example, could be used. It is also contemplated that materials other than metals, such as thermoplastic composites, could be used. In some embodiments, the sheet metal is at least 2 mm thick. The frame support 300 is manufactured without welds, and as such is considered to be weldless. The frame support 300 is also manufactured without mechanical fasteners and without adhesive. As will be described below, the frame support 300 is welded to the other components of the rear frame 12C, but the frame support 300 itself is formed without welds prior to its integration with the rest of the rear frame portion 12C. The structure of the frame support 300 shown in FIGS. 17 to 22 is the result of the stamping manufacturing process which will be described below.

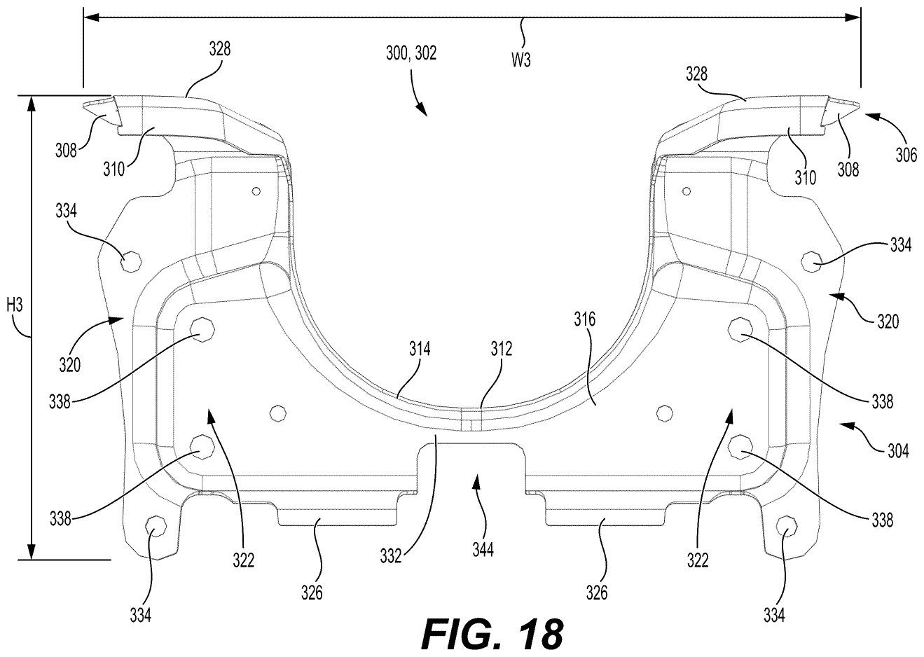

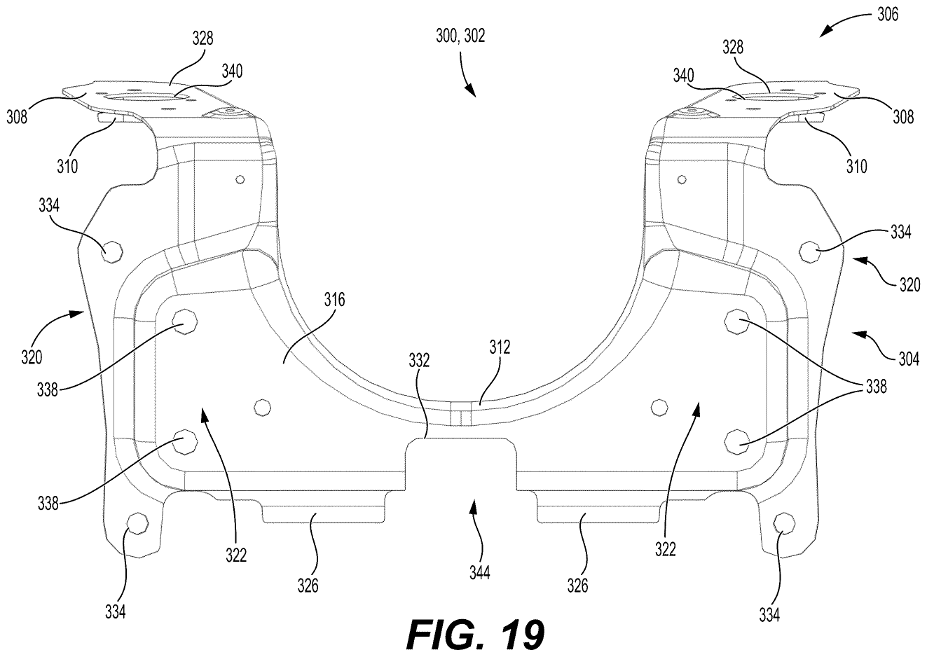

With reference to FIGS. 18 and 19, the frame support 300 has a length L3, a width W3, and a height H3. As can be seen, in the present embodiment, the width W3 is greater than the length L3 and greater than the height H3. It is contemplated that in alternative embodiment, the width W3 could be greater than only one of the length L3 and the height H3. In one embodiment, the length L3 is about 295 mm, the width W3 is about 460 mm, and the height H3 is about 255 mm.

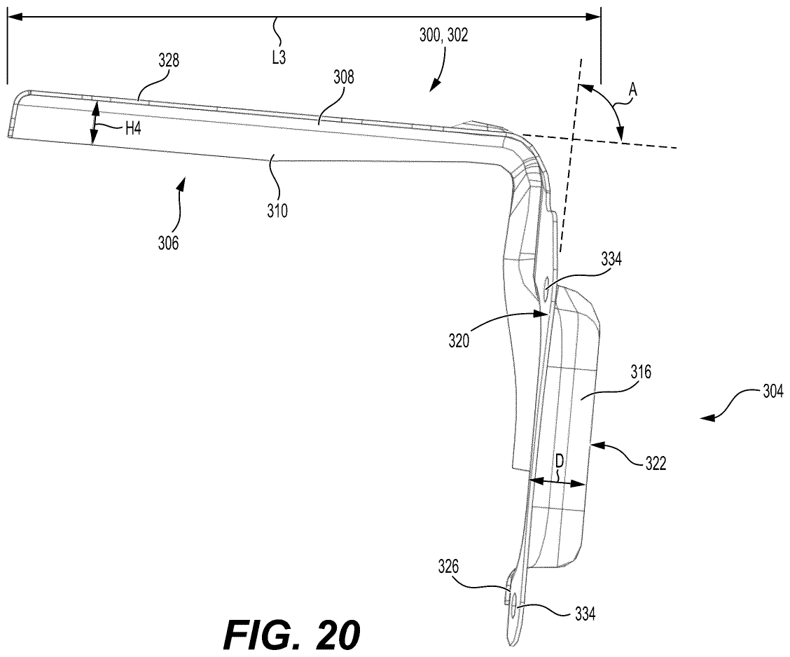

The support body 302 has a first body portion 304 and a second body portion 306 extending forward from an upper end of the first body portion 304. The second body portion 306 is generally perpendicular to the first body portion 304. In the present embodiment, the angle A (FIG. 20) is 90 degrees, but it is contemplated that the angle A could be between 85 and 95 degrees. With the frame support 300 connected to the vehicle 2, the first body portion 304 is generally vertical and the second body portion 306 is generally horizontal.

The second body portion 306 has left and right arms 308 that are laterally spaced from each other and that extend forward from the upper end of the first body portion 304. The left and right arms 308 have left and right reinforcement lips 310. Each reinforcement lip 310 extend vertically downward from a front and laterally inner side of its respective arm 308. In some embodiments, each reinforcement lip 310 is at least 8 mm high, with reference to the height H4 in FIG. 20. In some embodiments, each reinforcement lip 310 is at least 16 mm high. In some embodiments, each reinforcement lip 310 is at least 24 mm high.

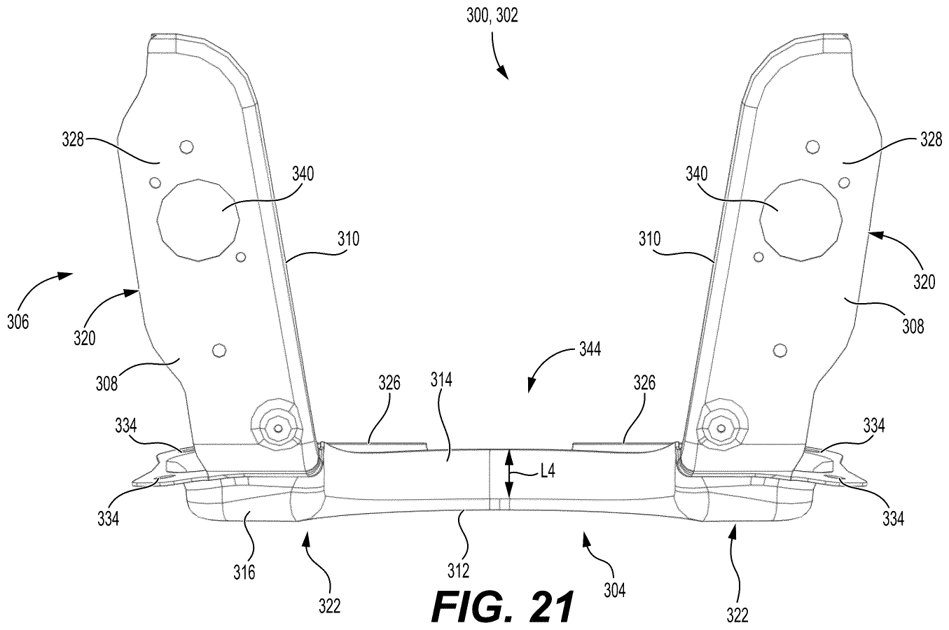

The first body portion 304 defines an upper U-shaped edge 312 extending between the left and right arms 308. The U-shaped edge 312 has a reinforcement lip 314 that extends forward by a length L4 (FIG. 21). In some embodiments, the reinforcement lip 314 is at least 8 mm long. In some embodiments, the reinforcement lip 314 is at least 16 mm long. In some embodiments, the reinforcement lip 314 is at least 24 mm long.

The first body portion 304 has a stamped recess 316 (i.e. a recess formed by stamping). The stamped recess 316 defines part of the U-shaped edge 312. The stamped recess 316 reinforces the first body portion 304. In some embodiments, the stamped recess 316 has a depth D (FIG. 20) of at least 20 mm. In some embodiments, the depth D is at least 25 mm. In some embodiments, the depth D is at least 30 mm.

The support body 302 defines left and right portions 320 configured for connecting to the left and right rear suspension mounts 60 respectively; left and right torsion bar mounting portions 322 configured for connecting left and right torsion bar mounts 324 (FIG. 5) used for mounting the torsion bar 72; left and right skid plate connection portions 326 configured for connecting to the skid plate 200; left and right powertrain mounting portions 328 configured for connecting to a powertrain mount 330 (FIG. 5); and a hitch connection portion 332 configured for connecting to the hitch receiver 400. It is contemplated that in alternative embodiments the support body 302 could define only one or more than two of each of the torsion bar mounting portions 322, the skid plate connection portions 326, and the powertrain mounting portions 328. It is contemplated that in alternative embodiments the support body 302 could define more than one hitch connection portion 332 or that the hitch connection portion 332 could be omitted.

The left side of the first body portion 304 and the left side of the second body portion 306 together define the left portion 320. More specifically, the left portion of the first body portion 304 excluding the portion raised by the stamped recess 316, the rear part of the left arm 308, and the left edges of the middle and front parts of the left arm 308 together define the left portion 320. Similarly, the right side of the first body portion 304 and the right side of the second body portion 306 together define the right portion 320. More specifically, the right portion of the first body portion 304 excluding the portion raised by the stamped recess 316, the rear part of the right arm 308, and the right edges of the middle and front parts of the right arm 308 together define the right portion 320. Each of the left and right portions 320 defines two apertures 334 on the first body portion 304. When the frame support 300 is mounted to the rear frame portion 12C, the apertures 334 receive fasteners 336 (FIG. 5) therethrough. The fasteners 336 fasten the lower and upper arms 62, 64 of the rear suspensions 13B to the lower rear arms 60C of the suspension mounts 60.

The first body portion 304 defines the left and right torsion bar mounting portion 322. More specifically, the left and right torsion bar mounting portions 322 are defined on the left and right sides of the stamped recess 316. Each torsion bar mounting portion 322 defines two apertures 338. The apertures 338 receive the fasteners of the left and right torsion bar mounts 324 used to fasten the mounts 324 to the frame support 300. In the present embodiment, the torsion bar mounts 324 are pillow blocks through which the torsion bar 72 passes.

The lower portion of the first body portion 304 defines the left and right skid plate connection portions 326. In the present embodiment, the skid plate connection portions 326 are tabs disposed below the stamped recess 316 on either side of the hitch connection portion 332.

The second body portion 306 defines the left and right powertrain mounting portions 328. More specifically, the left and right powertrain mounting portions 328 are defined by the left and right arms 308 respectively. Each powertrain mounting portion 328 defines an aperture 340. When the frame support 300 is mounted to the rear frame portion 12C, the apertures 340 receive vibration dampers (not shown) used to fasten left and right sides of the powertrain mount 330 that sits on and extends between the left and right arms 308. Left and right arms 342 (FIG. 5, only a left one of which is shown) are fastened to the powertrain mount 330 and extend downward therefrom on either side of a portion of the powertrain, specifically the transaxle 54 in the present embodiment. The transaxle 54 is fastened to the arms 342. As such, the frame support 300 supports the powertrain via the powertrain mount 330 and the arms 342.

The first body portion 304 defines the hitch connection portion 332 at a lateral center thereof. More specifically, the hitch connection portion 332 is defined by a recess 344 disposed between the skid plate connection portions 326 at a lower end of the first body portion 304.

The frame support 300 is connected to the other components of the vehicle 2 by welding. The placement of the support 300 in the rear frame portion 12C is such that the skid plate connection portions 326 abut the back of the rear reinforcement member 218 of the skid plate 200, the left and right sides of the first body portion 340 abut the rear lower arms 60C of the left and right suspension mounts 60, and the laterally outer edges of the arms 308 abut the laterally inner sides of the suspension mounts 60 as best shown in FIG. 6. The skid plate connection portions 326 are welded the back of the rear reinforcement member 218. The edges of the left and right portions 320 are welded to the left and right suspension mounts 60.

Turning now to FIGS. 5, 6, and 8 to 10, the hitch receiver 400 will be described in more detail. The hitch receiver 400 includes a L-shaped bracket 402 and a square hollow section 404 (SHS, i.e. a square tube), both of which are made of steel. It is contemplated that the bracket 402 and the SHS 404 could be made of a different metal. The L-shaped bracket 402 has a vertical portion 406 and a horizontal portion 408. The horizontal portion 408 extends forward from the lower end of the vertical portion 406. The SHS 404 passes through the vertical portion 406 of the bracket 402 and sits on the horizontal portion 408 of the plate 400. The SHS 404 is welded to both the vertical and horizontal portions 406, 408 of the bracket 402. The SHS 404 extends reward of the vertical portion 406 and forward of the horizontal portion 408. The portion of the SHS 404 that is rearward of the vertical portion 406 defines apertures 410.

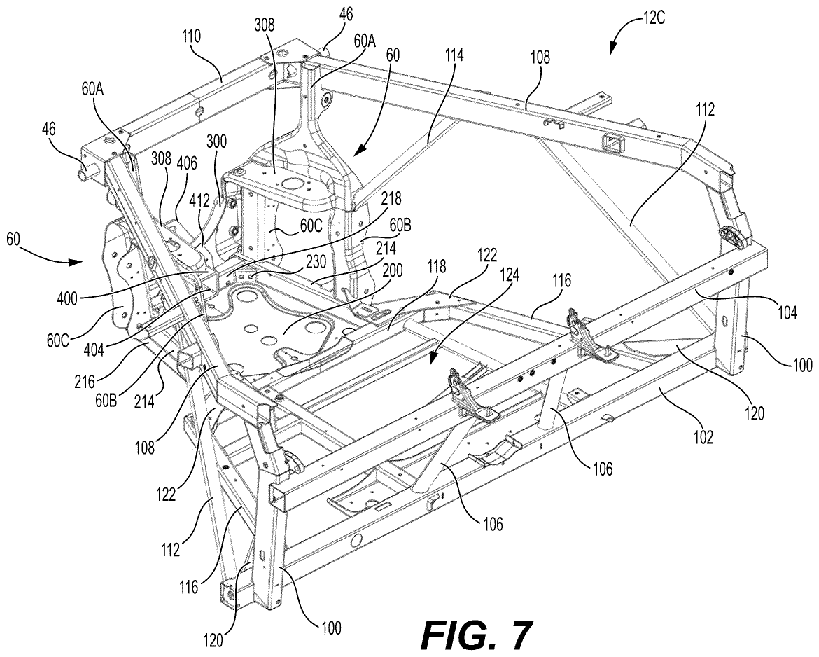

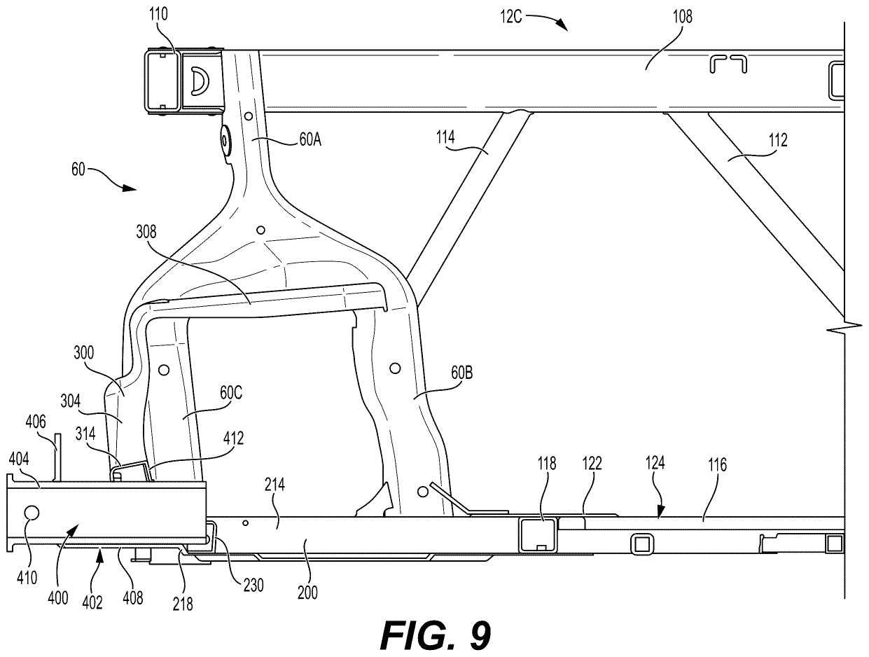

The hitch receiver 400 is connected to the other components of the vehicle 2 by welding. The front of the horizontal portion 408 extends under the rear reinforcement member 218 of the skid plate 200 and closes a bottom thereof. The front of the horizontal portion 408 is welded to the rear reinforcement member 218. The SHS 404 extends through the recess 344 of the hitch connection portion 322 of the frame support 300 and the recess 220 of rear reinforcement member 218 of the skid plate 200. The SHS 404 is welded to the contours of the recesses 220, 344. A plate 412 (FIGS. 7 and 9) straddles the SHS 404 and is welded to the SHS 404, the rear reinforcement member 218 and the reinforcement lip 314 of the frame support 300. With reference to FIG. 6, once the hitch receiver 400 is mounted to the vehicle 2, a hitch 414, which in FIG. 6 is a ball hitch, can be inserted in the SHS 404. The hitch 414 is secured to the hitch receiver 400 by a pin 416 inserted through the apertures 410 of the SHS 404 and a corresponding aperture (not shown) defined in the hitch 414.

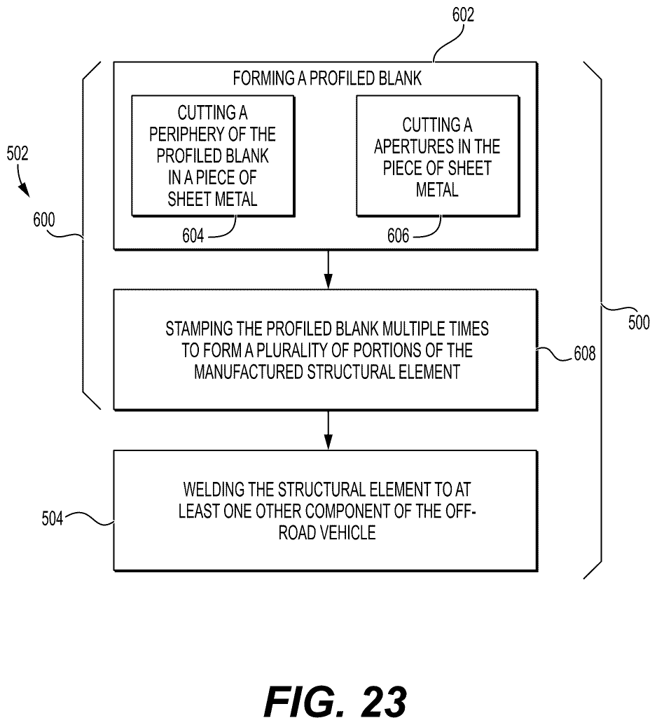

Turning now to FIG. 23, a method 500 for assembling an off-road vehicle will be described. The method 500 will be described with respect to the vehicle 2, but it is contemplated that it could be applied to other kinds of off-road vehicle. The method begins at 502 by manufacturing a structural element of the frame 12 of the vehicle 2. The structural element is manufactured according to a method 600. The structural element can be the skid plate 200 or the frame support 300 for example and is a weldless structural element. The method 600 will be described in detail below. Then at 504, the structural element is welded to at least one other component of the vehicle 2, such as the suspension mounts 60, the hitch receiver 400, and frame members of the frame 12. The components to which the skid plate 200 and the frame support 300 have been described above.

With continued reference to FIG. 23, the method 600 for manufacturing a structural element of a frame of an off-road vehicle will be described. The method 600 is used to manufacture the weldless skid plate 200 and the weldless frame support 300 described above.

The method 600 begins at 602 by forming a profiled blank. This is achieved by cutting a periphery of the profiled blank in a piece of sheet metal (step 604) and by cutting apertures in the piece of sheet metal (step 606) within the periphery of the profiled blank. It is contemplated that steps 604 and 606 could be performed in any order. It is also contemplated that steps 604 and 606 could be performed simultaneously. It is contemplated that step 604 can be performed by laser-cutting or punching. It is contemplated that step 606 can be performed by laser-cutting or punching. It is contemplated that other means for cutting sheet metal, such as waterjet cutting, plasma cutting, or sawing, could be used for steps 604 and/or 606. It is contemplated that the profiled blank could be formed without cutting the apertures, and that the apertures could be cut later in the method.

Once the profiled blank has been formed at step 602, then at step 608 the profiled blank is stamped multiple times to form a plurality of portions of the manufactured structural element. The resulting structural element is a weldless structural element that is free of welds, mechanical fasteners, and adhesives.

It is contemplated that the order of some of the steps of the method 600 could vary. For example, it is contemplated that the apertures could be cut between stamping operations.

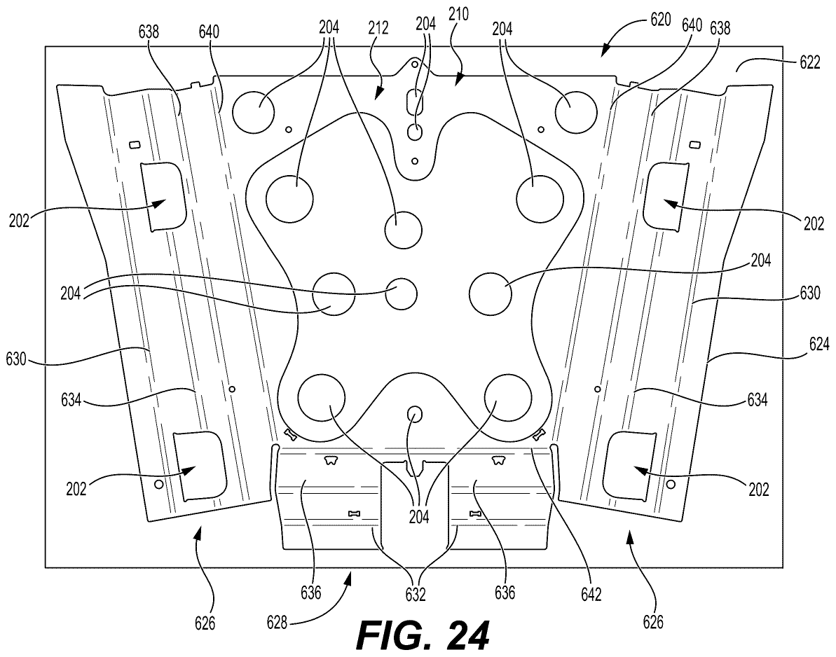

Turning now to FIGS. 24 to 31, the manufacturing of the skid plate 200 using the method 600 will be described in detail.

With reference to FIG. 24, as discussed above, the method starts by forming the profiled blank 620 (step 602). A piece of steel sheet metal 622 is provided and the periphery 624 of the profiled blank 620 is cut from the sheet metal 622 (step 604). The apertures 202, 204 (and the other unnumbered apertures) are also cut from the sheet metal 622 (step 606). As can be seen, the profiled blank 620 has the main portion 212 from which the frame connection portion 210, left and right side wings 626 and a rear wing 628 extend. The side wings 626 will become the left and right reinforcement members 214 and the rear wing 628 will become the rear reinforcement member 218. In the profiled blank 620, the main portion 212, the frame connection portion 210, and the wings 626, 628 are a flat sheet. It is contemplated that the piece of sheet metal 622 could be larger such that multiple profiled blanks 620 could be cut from the same piece of sheet metal 622. The lines appearing on the profiled blank 620 in the FIGS. 24 to 31 are only provided as a reference for where the profiled blank 620 is to be bent in the following steps and do not actually appear in the profiled blank 620.

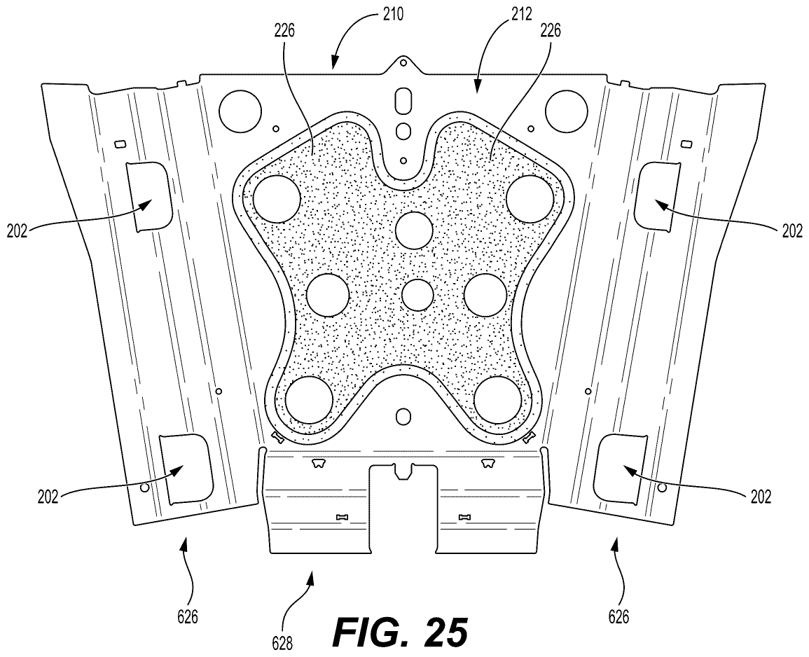

FIGS. 25 to 31 consecutively illustrate stamping operations of the multiple times the profiled blank 620 is to be stamped at step 608 in order to obtain the skid plate 200.

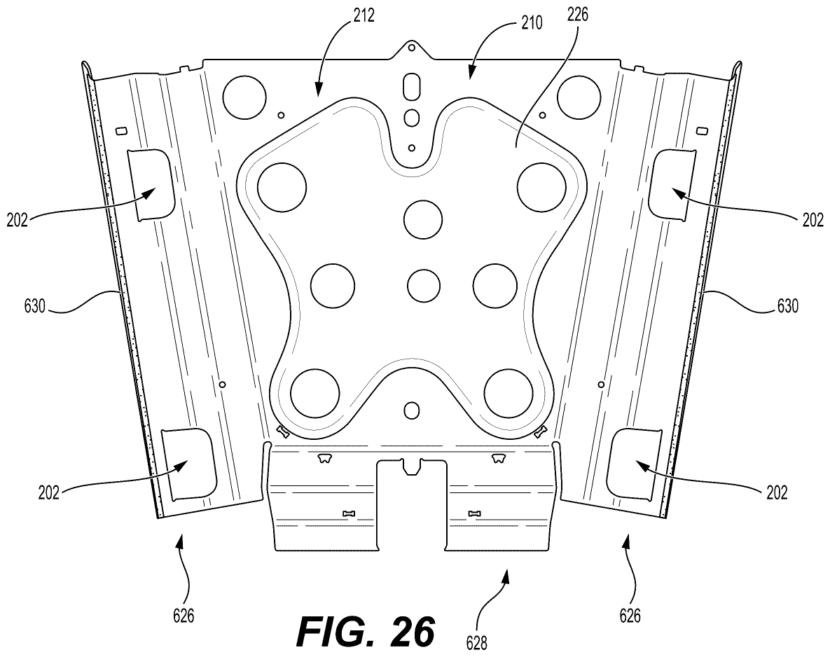

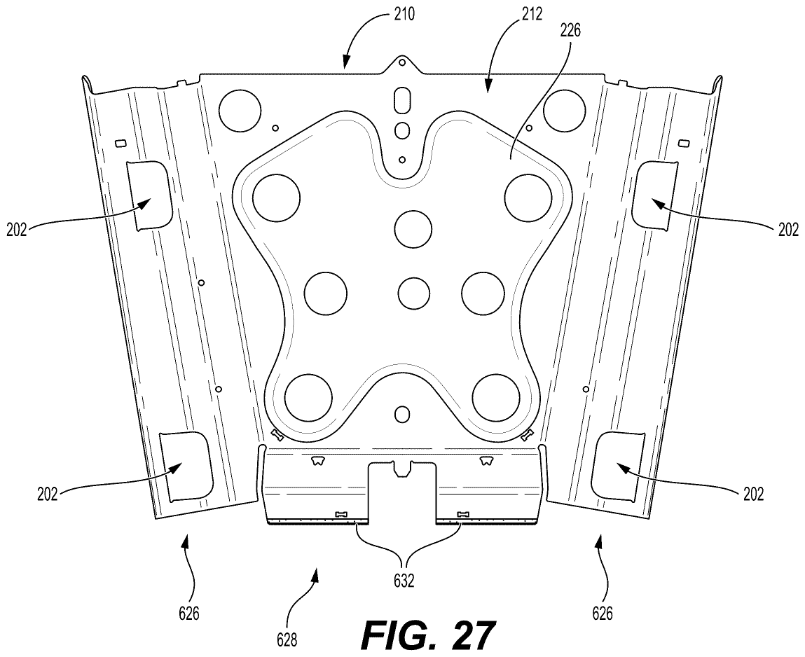

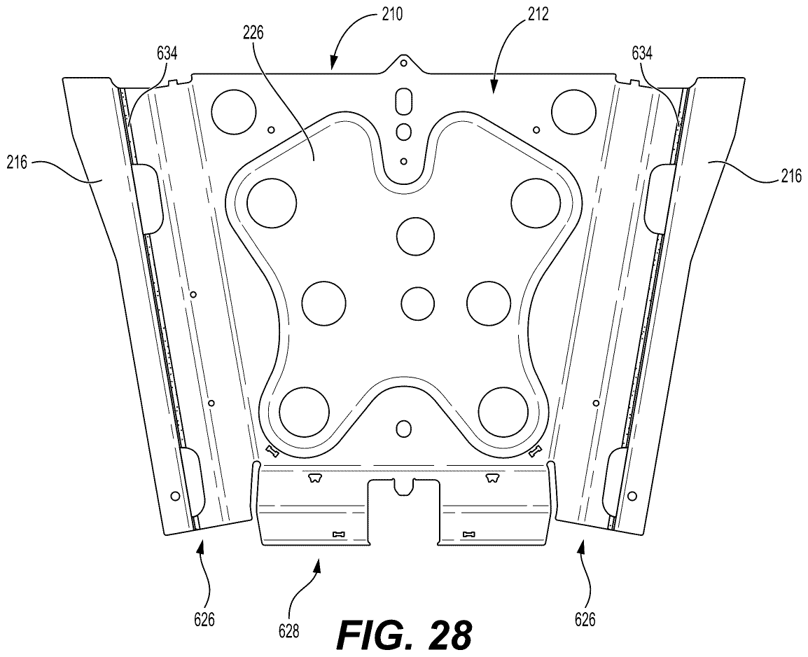

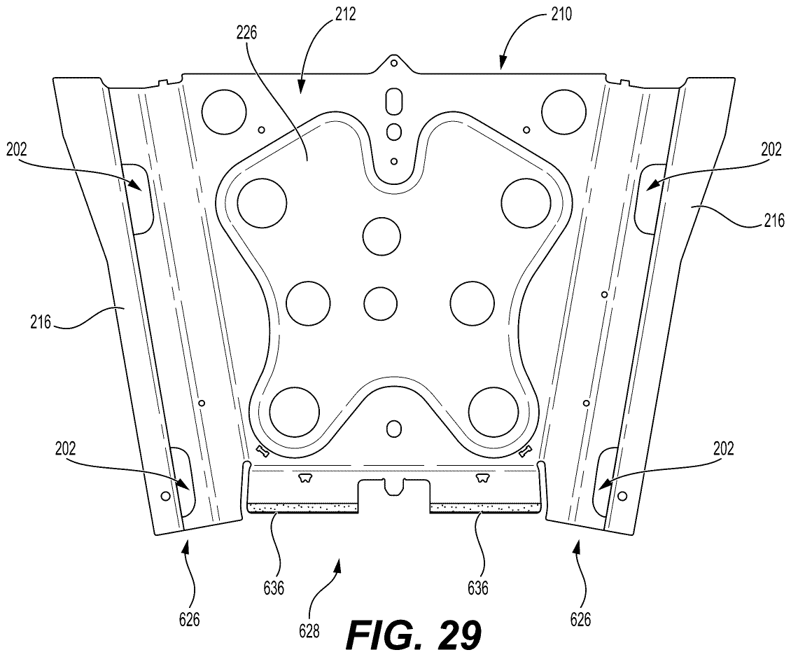

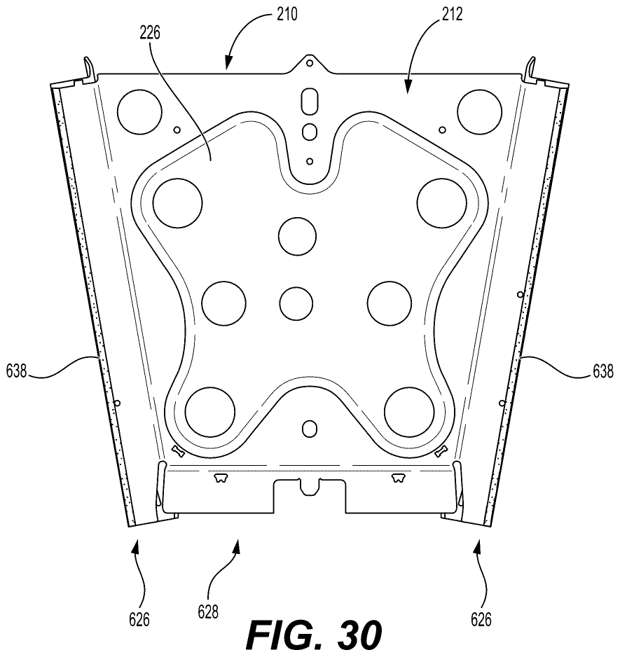

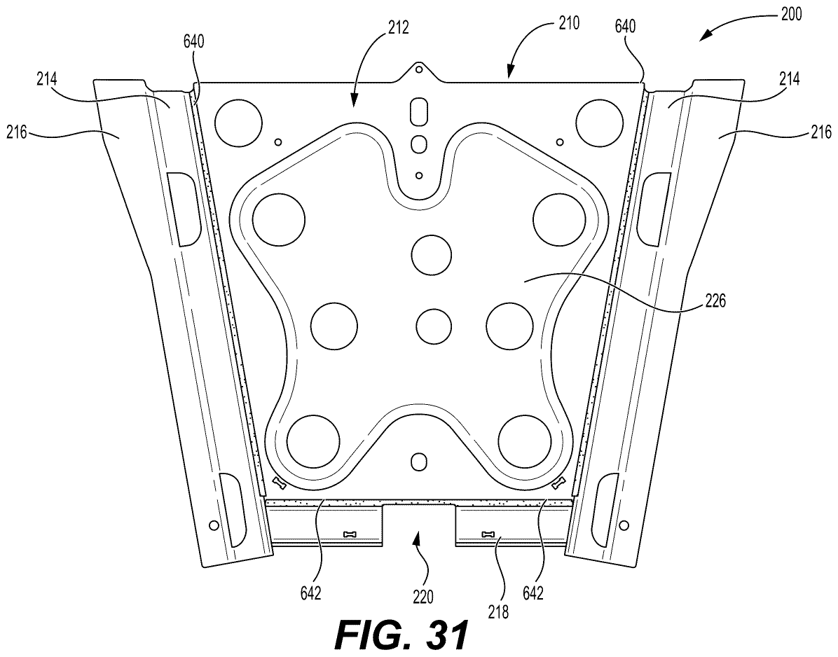

With reference to FIG. 25, the first stamping operation consists in stamping the main portion 212 to form the stamped recess 226. Then, with reference to FIG. 26, the wings 226 are stamped to bend the wings 226 along lines 630. Then, with reference to FIG. 27, the wing 228 is stamped to bend the wing 228 along the lines 632. Then, with reference to FIG. 28, the wings 226 are stamped to bend the wings 226 along lines 634. Then, with reference to FIG. 29, the wing 228 is stamped to bend the wing 228 along lines 636. Then, with reference to FIG. 30, the wings 226 are stamped to bend the wings 226 along lines 638. Finally, with reference to FIG. 31, the wings 226 are stamped to bend the wings 226 along lines 640, thus forming the left and right reinforcement members 214, and the wing 228 is stamped to bend the wing 228 along lines 642, thus forming the rear reinforcement member 218. The skid plate 200 is now manufactured and can be welded to the vehicle 2 as described above.

The manufacturing of the frame support 300 using the method 600 will be described in detail. The method starts by forming the profiled blank for the frame support 300. A piece of steel sheet metal is provided, and an approximate periphery of the profiled blank is cut from the sheet metal. The resulting part is a generally U-shaped piece of sheet metal. Then the profiled blank is stamped to form the stamped recess 316. Then the resulting part is cut more precisely around the portions that are to become the arms 308. Then the part is stamped to bend the sheet metal to form the reinforcement lips 310, 314. Then the part is stamped to bend the sheet metal to place the arms 308 generally perpendicular to the first body portion 304. Then the holes 340 are cut in the arms 308. Then the holes 334, 338 are cut in the first body portion 304. Finally, the lower portion of the first body portion 304 is cut more precisely to define the contours of the skid plate connection portions 326 and the recess 344. The frame support 300 is now manufactured and can be welded to the vehicle 2 as described above.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. A skid plate for an off-road vehicle, the skid plate comprising:
a left portion configured for connecting to a left suspension mount of the off-road vehicle;
a right portion configured for connecting to a right suspension mount of the off-road vehicle;
a rear portion configured for connecting to a hitch receiver of the off-road vehicle;
a frame connection portion configured for connecting to a frame member of the off-road vehicle; and
a main portion connecting the left portion, the right portion, the rear portion and the frame connection portion to each other, the main portion being weldless.

2. The skid plate of claim 1, wherein at least one of the left portion, the right portion and the rear portion comprises a reinforcement member.

3. The skid plate of claim 2, wherein the reinforcement member of the at least one of the left portion, the right portion and the rear portion is a channel having an opened side.

4. The skid plate of claim 3, wherein the channel of the at least one of the left portion, the right portion and the rear portion is an inverted U-shaped channel.

5. The skid plate of claim 2, wherein:
the reinforcement member is a left reinforcement member, a right reinforcement member, and a rear reinforcement member;
the left portion comprises the left reinforcement member;
the right portion comprises the right reinforcement member; and
the rear portion comprises the rear reinforcement member.

6. The skid plate of claim 5, wherein:
the left reinforcement member defines at least one aperture for receiving the left suspension mount therein; and
the right reinforcement member defines at least one aperture for receiving the right suspension mount therein.

7. The skid plate of claim 6, wherein:
the left reinforcement member defines two apertures for receiving two lower arms of the left suspension mount therein; and
the right reinforcement member defines two apertures for receiving two lower arms of the right suspension mount therein.

8. The skid plate of claim 5, wherein the rear reinforcement member defines a recess for receiving a portion of the hitch receiver therein.

9. The skid plate of claim 1, wherein:
the skid plate has a surface area; and
the skid plate defines a plurality of apertures.

10. The skid plate of claim 9, wherein a surface area of the plurality of apertures corresponds to at least 5 percent of the surface area of the skid plate.

11. The skid plate of claim 1, wherein the frame connection portion is disposed at a front of the skid plate.

12. The skid plate of claim 1, wherein the skid plate is formed from steel sheet metal.

13. The skid plate of claim 12, wherein the sheet metal is at least 2 mm thick.

14. The skid plate of claim 1, wherein the skid plate has a weight of less than 4.3 kg.

15. The skid plate of claim 1, comprising:
a length;
a front width at a front of the skid plate; and
a rear width at a rear of the skid plate;
wherein the front width is greater than the rear width.

16. The skid plate of claim 15, wherein the front width is greater than the length.

17. The skid plate of claim 1, wherein the main portion has a stamped recess.

18. The skid plate of claim 1, wherein the left portion, the right portion, the rear portion, the frame connection portion, and the main portion are connected to each other without welds, mechanical fasteners, and adhesives.

19. A method for manufacturing a structural element of a frame of an off-road vehicle, the method comprising:
forming a profiled blank by cutting a periphery of the profiled blank in a piece of sheet metal;
cutting apertures in the piece of sheet metal within the periphery of the profiled blank; and
stamping the profiled blank multiple times to form a plurality of portions of the manufactured structural element.

20. The method of claim 19, wherein the manufactured structural element is weldless.
